(19) United States
(12) Patent Application Publication
(10) Pub. No.: US 2026/0169665 A1
(43) Pub. Date: Jun. 18, 2026

(54) INFORMATION PROCESSING APPARATUS, INFORMATION PROCESSING SYSTEM, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: DAIKI KIRIYAMA, Kanagawa (JP)

(21) Appl. No.: 19/411,726

(22) Filed: Dec. 8, 2025

(30) Foreign Application Priority Data
Dec. 13, 2024 (JP) 2024-218853

(51) Int. Cl. G06F 3/12; G06V 30/41

(52) U.S. Cl. CPC G06F 3/1242; G06F 3/1204; G06V 30/41

(57) ABSTRACT

A field information creation unit of a client terminal creates field information, and transmits the created field information to a database control unit of a data management server. The database control unit creates a new database based on the field information received from the field information creation unit. The database control unit determines whether or not the field information received from the field information creation unit includes a workflow creation instruction flag. The database control unit transmits database information related to the created database to a workflow control unit of a workflow creation server. The workflow control unit creates a workflow based on the database information received from the database control unit.

### BACKGROUND

### Field of the Technology

The present disclosure relates to an information processing technology for creating a workflow associated with an external database.

### Description of the Related Art

Conventionally, there is known workflow technology that allows a process of storing document data scanned by a device such as a multifunction peripheral (MFP) directly in an external service, a process of simultaneously registering additional information of the document data in a database of the external service, and the like, to be automatically performed. In order to associate a workflow with a database, such as in a case where data obtained by a workflow executed on a device is registered in a database provided by an external service, it is necessary to perform settings in advance on both the device side and the external service side. Japanese Patent Laid-Open No. 2022-142653 discloses a method of accepting, from a user through a website, settings for a database of an external service to be associated with a workflow on a device.

### SUMMARY

The present disclosure is characterized by including: an obtaining unit configured to obtain information for instructing creation of a workflow to be associated with a database and obtain database information including field information which is definition information of a data item of the database, a database identifier assigned to the database created for each document type, and a field identifier assigned to a field in which an item value of the data item is to be registered; and a creating unit configured to create, based on the database information, the workflow to be executed by an image forming apparatus, which forms a document image from which the item value is to be extracted, wherein the obtaining unit obtains the database identifier and the field identifier from an external server in which the database is created based on the field information.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram illustrating an outline of a system;

FIG. 2 is a diagram of the hardware configuration of an image forming apparatus;

FIG. 3A is a diagram of the hardware configuration of a client terminal;

FIG. 3B is a diagram of the hardware configuration of a workflow creation server and a data management server;

FIG. 4 is a diagram of the software configuration of the entire system;

FIG. 5A is a sequence diagram illustrating a processing flow of the image forming apparatus, the client terminal, the workflow creation server, and the data management server;

FIG. 5B is a flowchart diagram illustrating a processing flow of a database control unit;

FIG. 6 is a UI displayed on the client terminal at the time of setting field information;

FIG. 7 is a schematic diagram of a database created by the data management server;

FIG. 8 is a diagram illustrating database information to be transmitted from the data management server to the workflow creation server;

FIG. 9 is a UI displayed on the client terminal at the time of manually creating a workflow;

FIG. 10 is a UI of a workflow displayed on the image forming apparatus;

FIG. 11 is a sequence diagram illustrating a processing flow of the image forming apparatus, the client terminal, the workflow creation server, and the data management server;

FIG. 12 is a sequence diagram illustrating a processing flow of the image forming apparatus, the client terminal, the workflow creation server, and the data management server; and

FIG. 13 is a UI displayed on the client terminal at the time of setting field information and OCR coordinate information from a scanned image of a document.

### DESCRIPTION OF THE EMBODIMENTS

However, in the technology of Japanese Patent Laid-Open No. 2022-142653, a field identifier of a database set by a user on a website and an identifier of the database itself need to be manually reflected in settings of a workflow to be executed on a device by the user, resulting in a problem that burdensome work is required.

Hereinafter, a description is given about forms for carrying out the present disclosure with reference to the drawings. Note that the following embodiments do not limit the invention according to the scope of the patent claims and that all combinations of the characteristics described in the embodiments are not necessarily essential to the solution provided by the invention.

### First Embodiment

### System Configuration

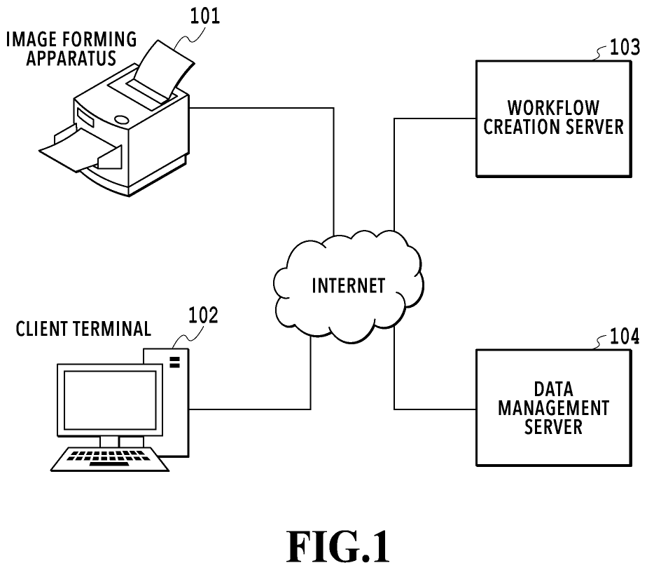

FIG. 1 illustrates a configuration example of the information processing system according to the present embodiment.

The image forming apparatus 101 is an example of a device that has at least one of a scanner function and a fax function, and may be a multifunction peripheral (MFP) that has both a scanner function and a fax function. The image forming apparatus 101 is capable of uploading data extracted from a document image, such as a scanned image or an image received by a fax, to the data management server 104. Further, the image forming apparatus 101 is capable of receiving a workflow that instructs processes to be executed, and executing the received workflow.

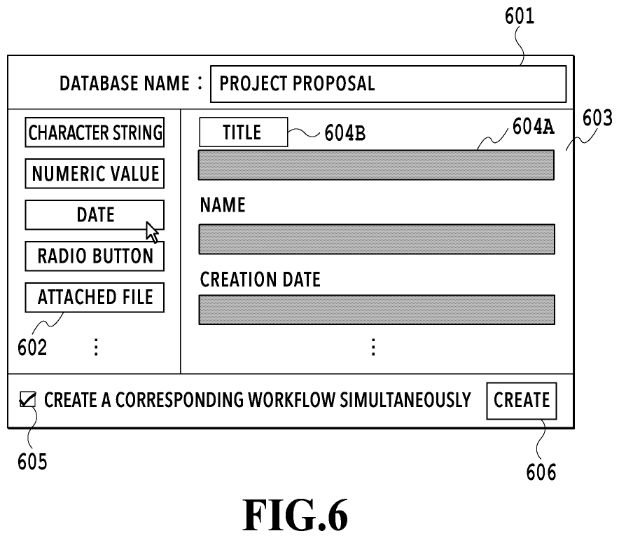

In the present embodiment, the client terminal 102 is an information processing apparatus such as a personal computer or a smartphone. At the time of creating a new database on the data management server 104, the client terminal 102 creates field information to be set in the database and transmits it to the data management server 104. Note that the field information may be transmitted directly from the client terminal 102 to the data management server 104, or may be transmitted via the workflow creation server 103. The details of the method for creating field information are described later with reference to FIG. 6.

The workflow creation server 103 creates a workflow to be associated with a database on the data management server 104, based on database information received from the data management server 104, and distributes it to the image forming apparatus 101. Note that the workflow created by the workflow creation server 103 to be associated with a database on an external server has a function of registering a scanned image, additional information, or the like, which is obtained along with the execution of the workflow, as a record of the database created by the data management server 104.

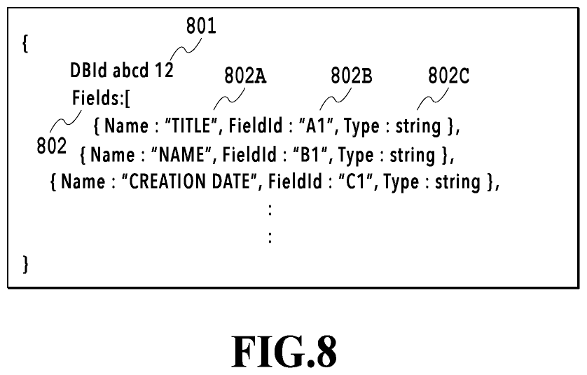

The data management server 104 creates a database based on field information received from the client terminal 102 or the workflow creation server 103, and transmits database information related to the created database. The details of database information are described later with reference to FIG. 8.

With the above-described configuration, by creating field information for a database in the client terminal 102 and transmitting it to the workflow creation server 103 or the data management server 104, a workflow associated with a database can be automatically created.

In the present embodiment, the image forming apparatus 101 and the client terminal 102 utilize an authentication and authorization mechanism such as OAuth, thereby implementing cooperation with the workflow creation server 103 and the data management server 104. Further, the same applies to the cooperation between the workflow creation server 103 and the data management server 104.

The above-described components are communicably connected to each other via a network. For example, the network may be a LAN such as the Internet, a WAN, a telephone line, or the like. Alternatively, it is a communication network implemented by a combination of these. It may be any network that is capable of transmitting and receiving data.

### Hardware Configuration of the Image Forming Apparatus

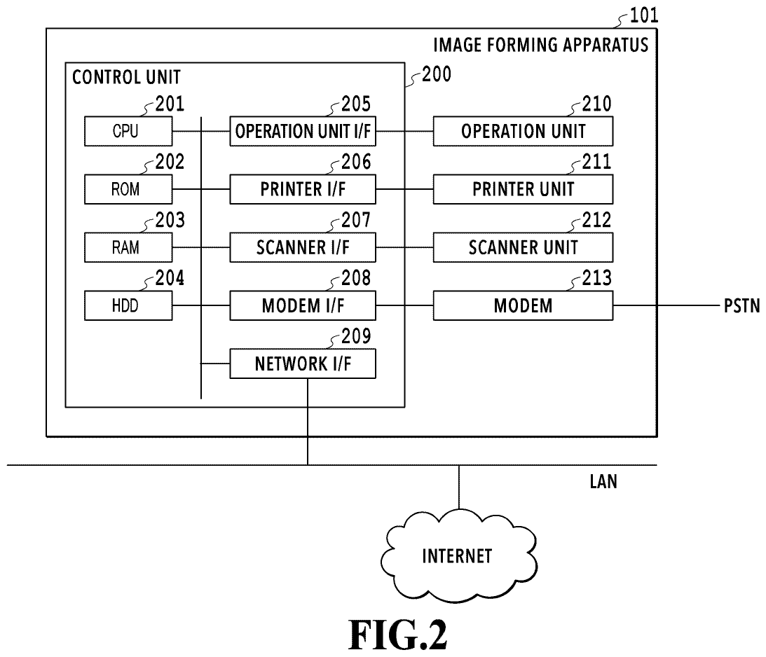

FIG. 2 illustrates an example of the hardware configuration of the image forming apparatus 101 according to the present embodiment. The image forming apparatus 101 is an MFP including the control unit 200, the operation unit 210, the printer unit 211, the scanner unit 212, and the modem 213. The control unit 200 includes each of the following units 201 to 209 and controls the overall operation of the image forming apparatus 101. The CPU 201 reads out a control program stored in the ROM 202 to execute and control various functions that the image forming apparatus 101 has, such as reading, printing, and communicating. The RAM 203 is used as a temporary memory area such as a main memory or work area of the CPU 201. Note that, although the one CPU 201 executes each of the processes shown in the later-described flowchart by use of one memory (the RAM 203 or the HDD 204) in the present embodiment, there is no such limitation. For example, each process may be executed by cooperation of multiple CPUs and multiples RAMs or HDDs. The HDD 204 is a large-capacity auxiliary memory device that stores image data and various programs. The operation unit I/F 205 is an interface that connects the operation unit 210 and the control unit 200. The operation unit 210 includes a touch panel, a keyboard, and the like, and accepts an operation, input, or instruction by the user. The printer I/F 206 is an interface that connects the printer unit 211 and the control unit 200. Image data for printing is transferred from the control unit 200 to the printer unit 211 via the printer I/F 206 and printed on a print medium. The scanner I/F 207 is an interface that connects the scanner unit 212 and the control unit 200. The scanner unit 212 reads a document that is set on a platen glass or an ADF (Auto Document Feeder) (not illustrated in the drawings) to generate image data, and inputs it to the control unit 200 via the scanner I/F 207. The image forming apparatus 101 is capable of using the printer unit 211 to print (copy) image data generated by the scanner unit 212 as well as performing file transmission or email transmission of the image data. The modem I/F 208 is an interface that connects the modem 213 and the control unit 200. The modem 213 performs facsimile communication of image data with a fax on PSTN. The network I/F 209 is an interface that connects the control unit 200 of the image forming apparatus 101 to a LAN. The image forming apparatus 101 uses the network I/F 209 to transmit image data and information to various services on the Internet and to receive various types of information.

### Client Terminal, Workflow Creation Server, and Data Management Server

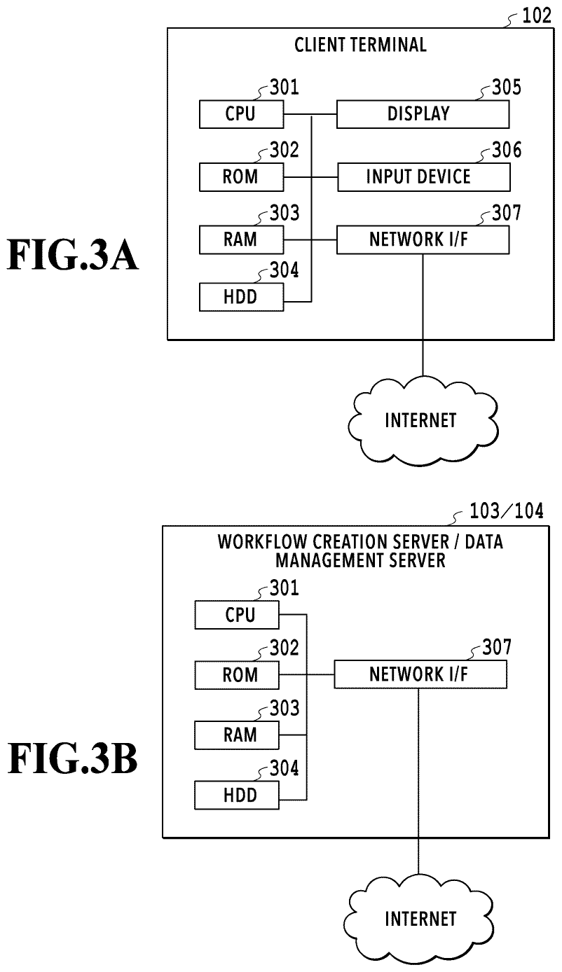

FIG. 3A illustrates an example of the hardware configuration of the client terminal 102, and FIG. 3B illustrates an example of the hardware configuration of the workflow creation server 103 and the data management server 104.

The client terminal 102, the workflow creation server 103, and the data management server 104 each include the CPU 301, the ROM 302, the RAM 303, the HDD 304, and the network I/F 307. The client terminal 102 further includes the display 305 and the input device 306. The CPU 301 controls the overall operation by reading out a control program stored in the ROM 302 and executing various kinds of processing. The RAM 303 is used as a temporary memory area such as a main memory or work area of the CPU 301. The HDD 304 is a large-capacity auxiliary memory device that stores image data and various programs. The network I/F 307 is an interface that connects the client terminal 102, the workflow creation server 103, and the data management server 104 to the Internet. The client terminal 102, the workflow creation server 103, and the data management server 104 receive processing requests from one another via the network I/F 307 and transmit and receive various kinds of information. The display 305 displays various kinds of information. The input device 306 is a pointing device such as a mouse and a keyboard, and is used to input various kinds of information.

### Software Configuration of the Entire System

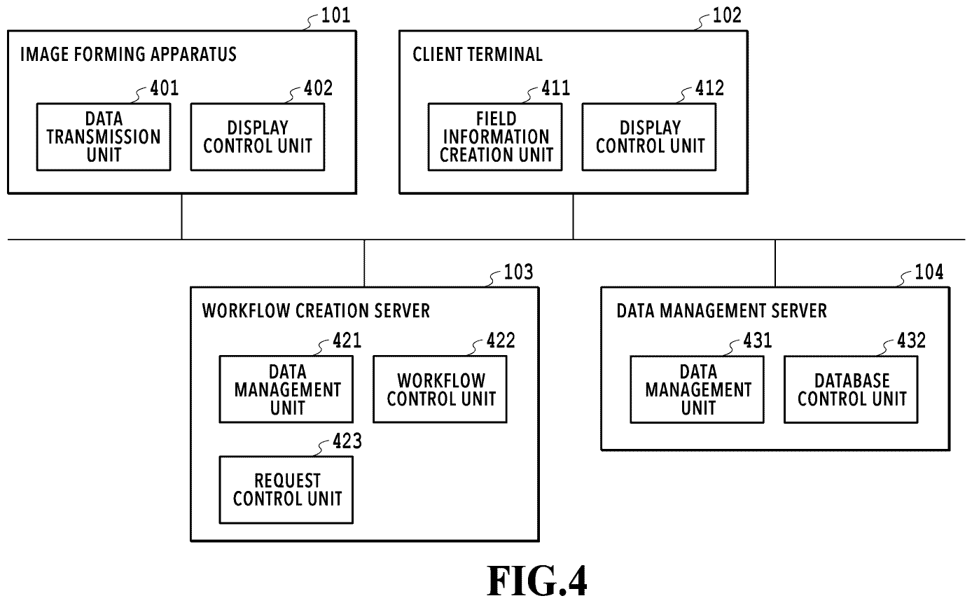

FIG. 4 illustrates an example of the software configuration of the entire system according to the present embodiment.

The image forming apparatus 101 includes the data transmission unit 401 and the display control unit 402. The data transmission unit 401 transmits a scanned image read by the scanner unit 212 or an image received by a fax to the workflow creation server 103. The display control unit 402 is capable of performing UI control for a workflow distributed from the workflow creation server 103.

The client terminal 102 includes the field information creation unit 411 and the display control unit 412. The field information creation unit 411 creates field information for a database created on the data management server 104, based on user input. The display control unit 412 performs UI control for the field information creation unit 411 to receive user input indicating field information.

The workflow creation server 103 includes the data management unit 421, the workflow control unit 422, and the request control unit 423. The data management unit 421 stores a scanned image transmitted from the image forming apparatus 101, field information transmitted from the client terminal 102, and database information transmitted from the data management server 104. The workflow control unit 422 creates a workflow based on received database information. The request control unit 423 transmits field information to the data management server 104 and distributes a workflow created by the workflow control unit 422 to the image forming apparatus 101.

The data management server 104 includes the data management unit 431 and the database control unit 432. The data management unit 431 manages input data for each field, which is transmitted from the image forming apparatus 101 or the client terminal 102. Note that the input data may be managed by the database control unit 432. The database control unit 432 creates a database based on received field information. It also transmits database information required for creating a workflow to the workflow creation server 103.

With the present configuration, the client terminal 102 transmits field information to the data management server 104, thereby making it possible to create a database. Further, the data management server 104 transmits database information to the workflow creation server 103, thereby making it possible for the image forming apparatus 101 to execute creation of a workflow associated with a database.

In the present embodiment, the image forming apparatus 101 and the client terminal 102 utilize an authentication and authorization mechanism such as OAuth, thereby implementing the cooperation with the workflow creation server 103. Further, the same applies to the cooperation with the data management server 104.

The above-described components are communicably connected to each other via a network. For example, the network may be a LAN such as the Internet, a WAN, a telephone line, or the like. Alternatively, it is a communication network implemented by a combination of these. It may be any network that is capable of transmitting and receiving data.

### Software Processing and Flowchart in the First Embodiment

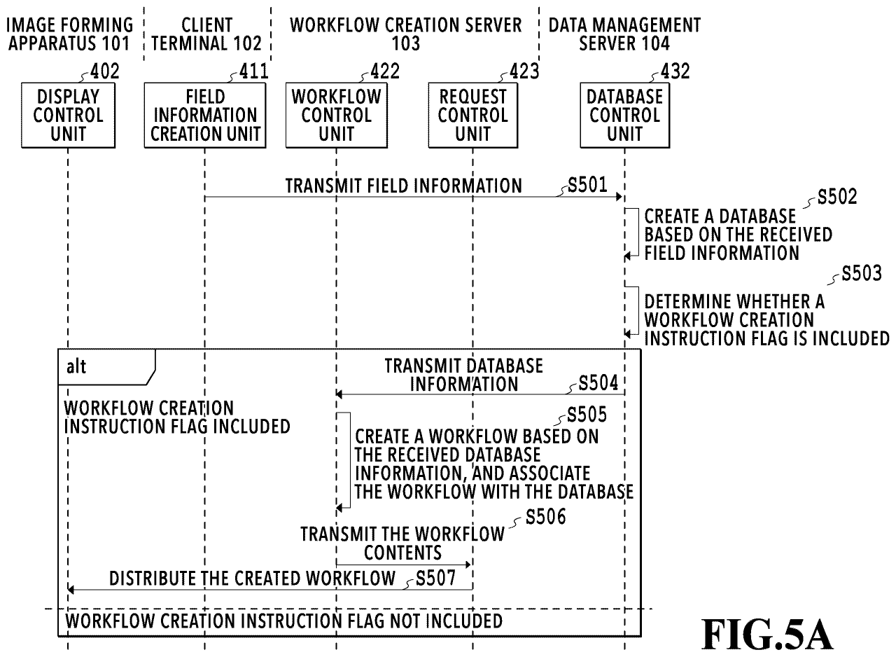

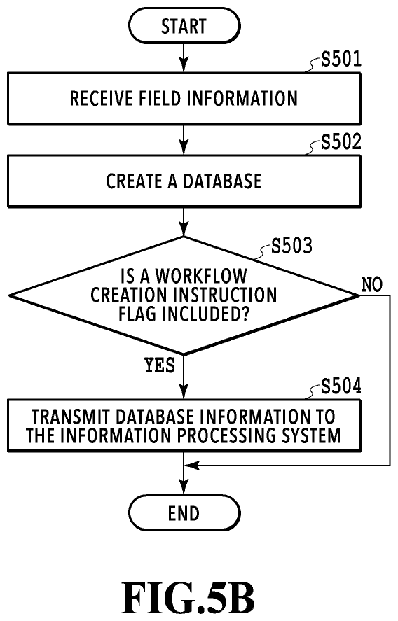

Hereinafter, a description is given about the processing for creating a database and then automatically creating a workflow associated with the database. FIG. 5A illustrates a sequence diagram for describing the processing among the image forming apparatus 101, the client terminal 102, the workflow creation server 103, and the data management server 104. FIG. 5B illustrates a flowchart for describing the processing performed by the database control unit 432.

In S501, based on a user input, the field information creation unit 411 of the client terminal 102 creates field information related to a database, which is created for each document type. The client terminal 102 transmits the created field information to the database control unit 432 of the data management server 104. The field information is composed of two elements for each field type, i.e., a field name and an input format of field values, and there are as many pieces of field information as the number of field types to be added to the database. Note that, in the present embodiment, field names correspond to item names, and field values correspond to item values. FIG. 6 illustrates a screen for creating field information in the present embodiment. The character string input in the database name input form 601 becomes the name of the database created for each document type in the data management server 104. By dragging and dropping each field type block 602 into the work area 603, the field value input form 604A is created. The field value input form 604A is an input form for directly registering a record in a database on the data management server 104 after the database is created, and is not available for input at the time of creating the field information. The input format of the field value input form 604A is determined by the type of the field type block 602, and may be, for example, a character string, a numeric value, a date, a selection, or a file. The name of the field value input form 604A is determined by the input to the field name input form 604B. If the create button 606 is pressed with the workflow creation check box 605 checked, a workflow creation instruction flag is added to the field information.

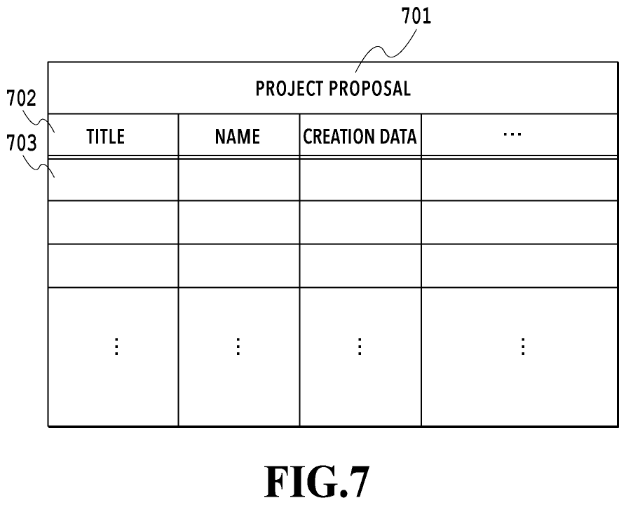

In S502, the database control unit 432 creates a new database based on the field information received from the field information creation unit 411. FIG. 7 illustrates an outline of the database to be created. The character string input to the database name input form 601 is registered as the title 701 of the database. Further, in the database, as many columns as the number of field value input forms 604A arranged in the work area 603 are created. In each field definition record 702, the character string input to each field name input form 604B is registered as the field name (item name) of each column. After the database is created, the field values input to the field value input forms 604A are registered in the data records 703, in the respective columns corresponding to the field names input to the field name input forms 604B.

In S503, the database control unit 432 determines whether or not the field information received from the field information creation unit 411 includes a workflow creation instruction flag. If a workflow creation instruction flag is included, the processing proceeds to S504; and if not, the processing ends.

In S504, the database control unit 432 transmits database information related to the database created in S502 to the workflow control unit 422 of the workflow creation server 103. FIG. 8 illustrates an example of the database information in the present embodiment. The database information in the present embodiment includes the database identifier 801 and the field specification 802. Further, the field specification 802 is composed of the field names 802A, the field identifiers 802B, and the field types 802C.

The database identifier 801 is automatically generated and assigned to each database by the data management server 104 at the time the database is created, so that the database can be uniquely identified within the data management server 104.

The field specification 802 is formed in an array containing multiple elements, and the elements are present for each field contained in all the data records 703 of the created database, i.e., for each field to which a field value is to be registered. The field names 802A are the same character strings as the field names registered in the respective columns of the field definition records 702. The field identifiers 802B are normally automatically generated and assigned to each field by the data management server 104, so that the field can be uniquely identified within the database. However, the field identifiers 802B may each be a value that is set as one of the pieces of information included in the field information transmitted from the client terminal 102 in S501. The field types 802C indicate the input formats of the respective field type blocks 602 selected in S501.

The database information is in JSON format in the example illustrated in FIG. 8, but may also be in XML format or the like. Further, the database information in the present embodiment is composed of the database identifier 801, the field names 802A, the field identifiers 802B, and the field types 802C, but other elements may be added as necessary.

In S505, the workflow control unit 422 creates a workflow based on the database information received from the database control unit 432.

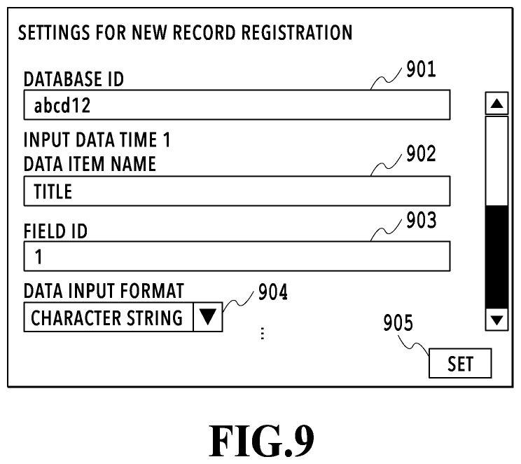

FIG. 9 illustrates a workflow setting information input screen displayed on the client terminal 102 in a case where a user manually creates a workflow. By inputting the database identifier of the database to be associated to the database identifier input form 901, a specific database can be associated with a workflow. Further, the name of a data item to be obtained in the workflow can be input to the data item name input form 902, and the field identifier of a field included in the database can be input to the field identifier input form 903, respectively. Further, the format of input contained in the database can be input to the data input format input form 904. The above-described database identifiers, data item names, field identifiers, and input formats required to create a workflow associated with a database are collectively referred to as workflow setting information.

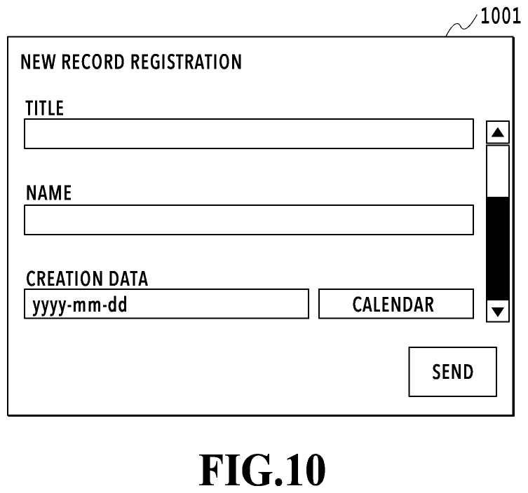

FIG. 10 illustrates a registration screen for registering the workflow setting information that is input. Each time one set of workflow setting information input on the input screen illustrated in FIG. 9 is set, one data input form 1001 is created for the workflow. A plurality of data input forms 1001 can be created for one workflow. Values that are input in the data input form 1001 are registered in the fields corresponding to the field identifiers that are input to the field identifier input form 903 in association with the workflow setting information.

The series of processes of inputting workflow setting information and creating a workflow is automatically performed by the workflow control unit 422. Specifically, the workflow control unit 422 sets the database identifier 801 in the database identifier input form 901 and sets the field names 802A in the data item name input form 902, respectively, based on the database information received from the database control unit 432. Further, the workflow control unit 422 sets the field identifiers 802B in the field identifier input form 903 and sets the field types 802C in the data input format input form 904, respectively. Note that the input values in the data item name input form 902 can be changed even after the workflow is created. In other words, the names of data items obtained in a workflow may be different from the corresponding field names in the database.

In S506, the workflow control unit 422 outputs the created workflow data to the request control unit 423. The request control unit 423 holds in advance a distribution destination, i.e., the image forming apparatuses 101, and is capable of distributing a workflow to the registered image forming apparatus 101.

In S507, the request control unit 423 distributes the workflow created in S505 to the image forming apparatus 101 registered in advance as a distribution destination. Regarding the distributed workflow, such a UI for registering workflow setting information as illustrated in FIG. 10 is displayed on the image forming apparatus 101, so that registering a record to the database can also be performed on the image forming apparatus 101.

In the present embodiment, the configuration is such that, if the database control unit 432 transmits database information to the workflow control unit 422 in accordance with a workflow creation instruction flag included in the field information, the workflow control unit 422 creates a workflow. However, the method for causing the workflow control unit 422 to create a workflow is not limited to this. For example, it is also possible that the field information creation unit 411 transmits a workflow creation instruction to the workflow control unit 422 at the time of transmitting field information to the database control unit 432, so that the workflow control unit 422 creates a workflow in accordance with the workflow creation instruction. In this case, if the workflow control unit 422 receives the workflow creation instruction, it may request database information from the database control unit 432 and obtain the database information. Further, the workflow creation instruction may include information indicating the corresponding field information, so that the workflow control unit 422 can request database information of a database created based on the field information corresponding to the workflow creation instruction.

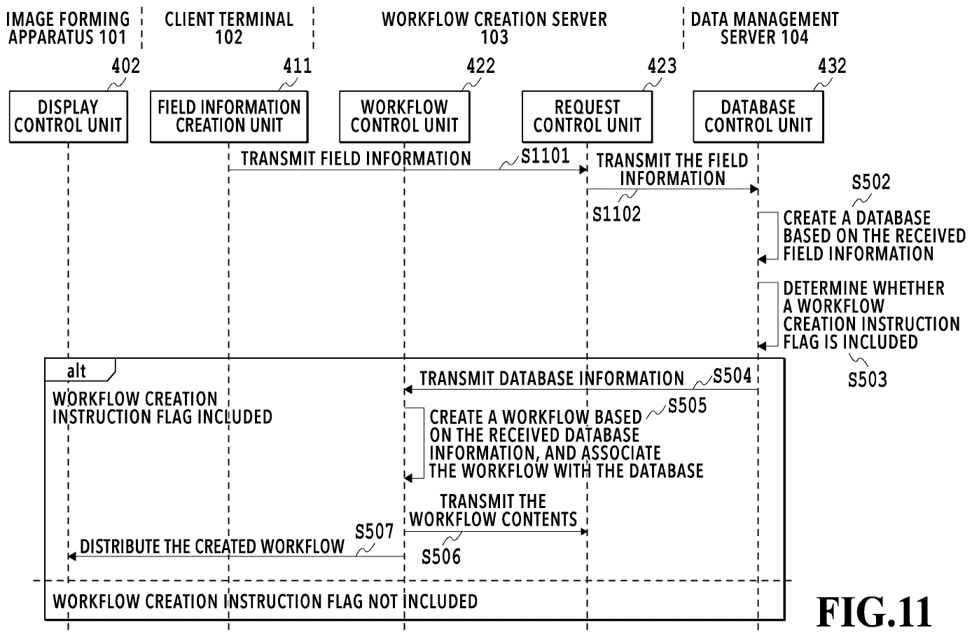

Note that the field information, which is definition information for defining a field in which data is registered in the database, may be transmitted from the field information creation unit 411 to the database control unit 432 via the request control unit 423. FIG. 11 illustrates a sequence diagram of a case in which field information is transmitted from the field information creation unit 411 to the database control unit 432 via the request control unit 423. In this case, S501 in the sequence diagram illustrated in FIG. 5A is replaced with S1101 and S1102. In S1101, the field information creation unit 411 transmits the created field information to the request control unit 423. Further, in S1102, the request control unit 423 transmits the field information received from the field information creation unit 411 to the database control unit 432. Further, in this case, instead of S503, the request control unit 423 may perform the following processes. That is, after transmitting the field information, the request control unit 423 determines whether or not the field information includes a workflow creation instruction flag. Then, if a workflow creation instruction flag is included in the field information, the request control unit 423 requests database information from the database control unit 432. In S504, the database control unit 432 transmits the database information to the workflow control unit 422 as a response to the request for database information from the request control unit 423.

Further, the configuration in the present embodiment is such that whether or not to create a workflow is determined based on the presence/absence of a workflow creation instruction flag; however, it is also possible not to use the workflow creation instruction flag. In a case where field information is input to the client terminal 102 and a database is created based on that field information, a workflow may be created unless a separate instruction not to create a workflow is given; and in that case, S503 can be omitted.

The above describes the methods for creating a database and a workflow at once by setting field information for a database. Accordingly, the user can skip burdensome work of creating a database and then creating a workflow manually with reference to its setting values.

### Second Embodiment

### Software Processing in the Second Embodiment

In the first embodiment described above, an explanation is given about a method for creating a database and workflow at once by setting, from the client terminal 102, field information for a database. However, the method does not allow for workflow settings that perform OCR processing on a scanned image obtained by reading a standard form document in the image forming apparatus 101 and register data extracted by the OCR processing in a database.

Therefore, in the second embodiment, in addition to the first embodiment, OCR settings based on a scanned image obtained by reading a document in the image forming apparatus 101 are added to the field information, and a workflow that can register the data extracted by the OCR processing in a database is automatically created. In the present embodiment, the client terminal 102 receives OCR coordinate information for specifying a region where the OCR processing is to be performed, and transmits the OCR coordinate information to the workflow creation server 103 together with field information. The data management unit 421 stores the OCR coordinate information transmitted from the client terminal 102. In the present embodiment, the same descriptions as in the first embodiment, such as the system configuration and application UIs, are omitted.

### Software Processing and Flowchart in the Second Embodiment

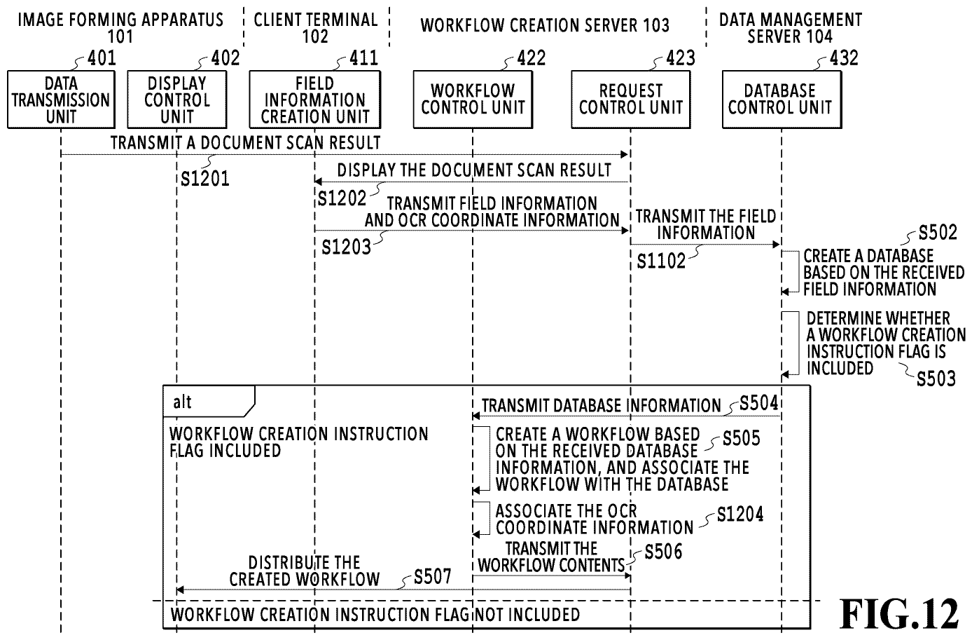

FIG. 12 illustrates a sequence diagram in the second embodiment for describing the processing among the image forming apparatus 101, the client terminal 102, the workflow creation server 103, and the data management server 104.

In S1201, the data transmission unit 401 transmits a scanned image of a document to the request control unit 423.

In S1202, the request control unit 423 transmits the scanned image of the document received from the data transmission unit 401 to the field information creation unit 411.

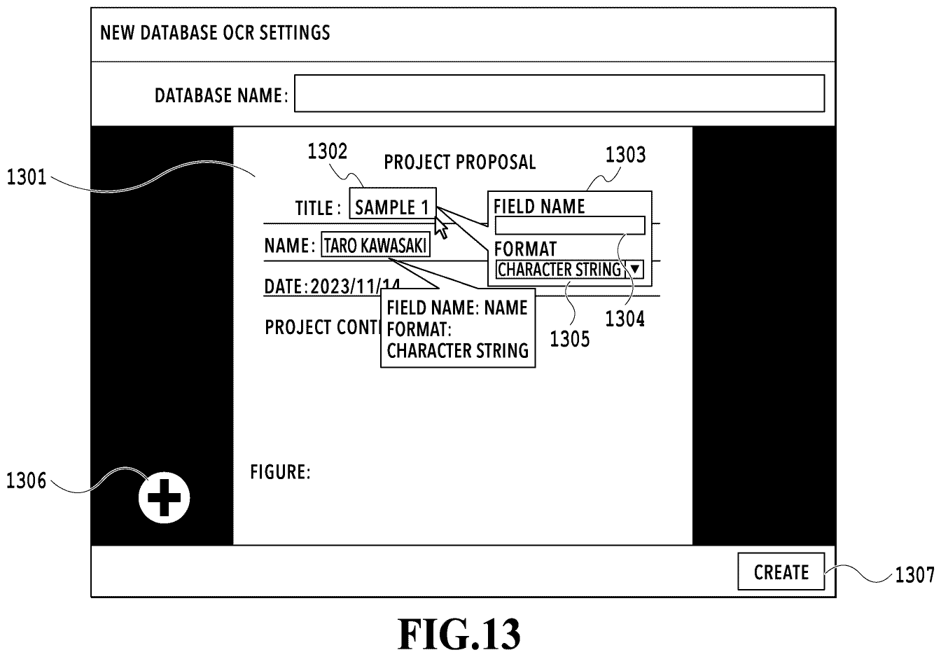

In S1203, the field information creation unit 411 creates field information and OCR coordinate information, and transmits the created field information and OCR coordinate information to the request control unit 423 of the data management server 104. FIG. 13 illustrates an example of the UI screen for receiving field information and OCR coordinate information based on a displayed scanned image of a document. A scanned image of a document is displayed in the OCR setting area 1301, and the user can set the extraction area 1302 on the displayed scanned image, in a region from which data is to be extracted by the OCR processing. If the extraction area 1302 is set, the input form balloon 1303 is displayed. The field name and input format of the data to be registered, which is extracted from the extraction area 1302 by the OCR processing, are set in the field name input form 1304 and the field format input form 1305, respectively. If the add button 1306 is pressed, the extraction area 1302 can be added. If the create button 1307 is pressed, OCR coordinate information for specifying the extraction area 1302 and field information corresponding to the OCR coordinate information are transmitted to the workflow creation server 103 for the number of extraction areas.

In S1204, the workflow control unit 422 associates the OCR coordinate information received from the field information creation unit 411 with each data input form 1001 of the workflow. The OCR coordinate information and the data input form 1001 are associated with each other in the same manner as the database identifier 801, the field names 802A, the field identifiers 802B, and the field types 802C. This associating process allows data extracted from within an OCR coordinate region in the scanned image of a document to be registered in the corresponding field of the associated database.

In the above, regarding a workflow created together with a database, a description is given about a method for simultaneously performing workflow settings in which data extracted from a scanned image of a standard form document by OCR processing is registered in a database. Accordingly, the user can skip burdensome work required for creating a database and a workflow corresponding to new standard form documents.

Note that, in the present embodiment, the data extracted by OCR processing is associated with field information based on OCR coordinate information; however, the configuration may be such that the extracted data and the field information are associated with each other based on the relation degree between extracted data and a field name. In this case, even without OCR coordinate information, it is possible to create a workflow in which data extracted by OCR processing is registered in a database, as in the present embodiment.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, a workflow that can register data in a created database can be automatically created.

This application claims the benefit of Japanese Patent Application No. 2024-218853, filed Dec. 13, 2024, which is hereby incorporated by reference herein in its entirety.

What is claimed is:

1. An information processing apparatus comprising at least one memory and at least one processor which function as:
an obtaining unit configured to obtain information for instructing creation of a workflow to be associated with a database and obtain database information including field information which is definition information of a data item of the database, a database identifier assigned to the database created for each document type, and a field identifier assigned to a field in which an item value of the data item is to be registered; and
a creating unit configured to create, based on the database information, the workflow to be executed by an image forming apparatus, which forms a document image from which the item value is to be extracted,
wherein the obtaining unit obtains the database identifier and the field identifier from an external server in which the database is created based on the field information.

2. The information processing apparatus according to claim 1,
wherein, in the database corresponding to the document type represented by the document image, the creating unit registers the item value extracted from the document image in the field to which the field identifier corresponding to the item value is assigned.

3. The information processing apparatus according to claim 1 further comprising
a transmitting unit configured to transmit the workflow to the image forming apparatus.

4. The information processing apparatus according to claim 1,
wherein the workflow includes OCR processing to be performed on the document image for extracting the item value corresponding to the data item.

5. The information processing apparatus according to claim 4,
wherein, for each data item defined in the field information, the obtaining unit obtains OCR coordinate information indicating a region where the OCR processing is to be performed in the document image, and
wherein the OCR processing in the workflow is performed based on the OCR coordinate information.

6. The information processing apparatus according to claim 1,
wherein, upon obtaining the information for instructing creation of the workflow from a client terminal that accepts user input, the obtaining unit requests the database information from the external server.

7. The information processing apparatus according to claim 1,
wherein the information for instructing creation of the workflow is a workflow creation instruction flag included in the field information.

8. The information processing apparatus according to claim 1,
wherein the image forming apparatus includes at least one of a scanner and a facsimile, and
wherein the document image is a read image obtained by reading a document using the scanner or a document image received by the facsimile.

9. An information processing system comprising:
a data management server configured to obtain field information which is definition information of a data item, and create a database for each document type based on the field information; and
a workflow creation server configured to obtain, from the data management server, database information including the field information, a database identifier assigned to the database, and a field identifier assigned to a field in which an item value of the data item is to be registered, and, based on the database information, create a workflow to be executed by an image forming apparatus, which forms a document image from which the item value is to be extracted.

10. The information processing system according to claim 9,
wherein the field information includes a workflow creation instruction flag, and
wherein, in a case where creation of the workflow is instructed by the workflow creation instruction flag, the data management server transmits the database information to the workflow creation server.

11. An information processing method comprising:
a step for obtaining information for instructing creation of a workflow to be associated with a database and obtaining database information including field information which is definition information of a data item of the database, a database identifier assigned to the database created for each document type, and a field identifier assigned to a field in which an item value of the data item is to be registered; and
a step for creating, based on the database information, the workflow to be executed by an image forming apparatus, which forms a document image from which the item value is to be extracted,
wherein, in the obtaining step, the database identifier and the field identifier are obtained from an external server in which the database is created based on the field information.

12. An information processing method comprising:
a step in which a data management server obtains field information which is definition information of a data item of a database, and creates the database for each document type based on the field information; and
a step in which a workflow creation server obtains, from the data management server, database information including the field information, a database identifier assigned to the database, and a field identifier assigned to a field in which an item value of the data item is to be registered, and, based on the database information, creates a workflow to be executed by an image forming apparatus, which forms a document image from which the item value is to be extracted.

13. A non-transitory computer readable storage medium storing a program for causing a computer to perform an information processing method, the information processing method comprising:
a step for obtaining information for instructing creation of a workflow to be associated with a database and obtaining database information including field information which is definition information of a data item of the database, a database identifier assigned to the database created for each document type, and a field identifier assigned to a field in which an item value of the data item is to be registered; and
a step for creating, based on the database information, the workflow to be executed by an image forming apparatus, which forms a document image from which the item value is to be extracted,
wherein, in the obtaining step, the database identifier and the field identifier are obtained from an external server in which the database is created based on the field information.

14. A non-transitory computer readable storage medium storing a program for causing a computer to perform an information processing method, the information processing method comprising:
a step in which a data management server obtains field information which is definition information of a data item of a database, and creates the database for each document type based on the field information; and
a step in which a workflow creation server obtains, from the data management server, database information including the field information, a database identifier assigned to the database, and a field identifier assigned to a field in which an item value of the data item is to be registered, and, based on the database information, creates a workflow to be executed by an image forming apparatus, which forms a document image from which the item value is to be extracted.
